(19) United States
(12) Patent Application Publication
(10) Pub. No.: US 2022/0172607 A1
(43) Pub. Date: Jun. 2, 2022

(54) SYSTEMS AND METHODS FOR PREDICTING A BICYCLE TRAJECTORY

(71) Applicant: BEIJING VOYAGER TECHNOLOGY CO., LTD., Beijing (CN)

(72) Inventors: Jian GUAN, Beijing (CN); Pei LI, Beijing (CN); You LI, Beijing (CN)

(73) Assignee: BEIJING VOYAGER TECHNOLOGY CO., LTD., Beijing (CN)

(21) Appl. No.: 17/674,794

(22) Filed: Feb. 17, 2022

Related U.S. Application Data
(63) Continuation of application No. PCT/CN2019/109350, filed on Sep. 30, 2019.

(51) Int. Cl. G08G 1/01; G01S 17/89; G01S 17/86; G08G 1/017; G08G 1/04; G08G 1/052

(52) U.S. Cl. CPC G08G 1/0112; G01S 17/89; G01S 17/86; B60W 60/0027; G08G 1/04; G08G 1/052; G08G 1/017

(57) ABSTRACT

Embodiments of the disclosure provide methods and systems for predicting a trajectory of a bicycle ridden by a cyclist. The system includes a communication interface configured to receive a map of an area in which the bicycle is traveling and sensor data acquired associated with the bicycle. The system includes at least one processor configured to position the bicycle in the map, identify the cyclist riding the bicycle, and identify one or more objects surrounding the bicycle based on the positioning of the bicycle. The at least one processor is further configured to extract features of the bicycle, the cyclist, and the one or more objects from the sensor data. The at least one processor is also configured to predict the trajectory of the bicycle based on the extracted features using a learning model.

### CROSS REFERENCE TO RELATED APPLICATIONS

This application is a bypass continuation to PCT Application No. PCT/CN2019/109350, filed Sep. 30, 2019. The present application is also related to PCT Application Nos. PCT/CN2019/109354, PCT/CN2019/109352, and PCT/CN2019/109351, each filed Sep. 30, 2019. The entire contents of all of the above-identified applications are incorporated herein by reference in their entireties.

### TECHNICAL FIELD

The present disclosure relates to systems and methods for predicting a bicycle trajectory, and more particularly, to systems and methods for predicting a bicycle trajectory using features extracted from map and sensor data.

### BACKGROUND

Vehicles share roads with other vehicles, pedestrians, bicycles, and objects, such as traffic signs, road blocks, fences, etc. Therefore, drivers need to constantly adjust driving to avoid colliding the vehicle with such obstacles. While some obstacles are generally static and therefore easy to avoid, some others might be moving. For a moving obstacle, the driver has to not only observe its current position but to predict its moving trajectory in order to determine its future positions. For example, a bicycle near the vehicle may go straight, stop, or make turns. The driver typically makes the prediction based on observations such as hand signals provided by the cyclist, the bicycle's traveling speed, etc.

Automatous driving vehicles need to make similar decisions to avoid obstacles. Therefore, automatous driving technology relies heavily on automated prediction of the trajectories of other moving obstacles. However, existing prediction systems and methods are limited by the vehicle's ability to “see” (e.g., to collect relevant data), ability to process the data, and ability to make accurate predictions based on the data. Accordingly, automatous driving vehicles can benefit from improvements to the existing prediction systems and methods.

Embodiments of the disclosure improve the existing prediction systems and methods in automatous driving by providing systems and methods for predicting a bicycle trajectory using features extracted from map and sensor data.

### SUMMARY

Embodiments of the disclosure provide a system for predicting a trajectory of a bicycle ridden by a cyclist. The system includes a communication interface configured to receive a map of an area in which the bicycle is traveling and sensor data acquired associated with the bicycle. The system includes at least one processor configured to position the bicycle in the map, identify the cyclist riding the bicycle, and identify one or more objects surrounding the bicycle based on the positioning of the bicycle. The at least one processor is further configured to extract features of the bicycle, the cyclist, and the one or more objects from the sensor data. The at least one processor is also configured to predict the trajectory of the bicycle based on the extracted features using a learning model.

Embodiments of the disclosure also provide a method for predicting a trajectory of a bicycle ridden by a cyclist. The method includes receiving, by a communication interface, a map of an area in which the bicycle is traveling and sensor data acquired associated with the bicycle. The method further includes positioning the bicycle in the map, identifying the cyclist riding the bicycle, and identifying one or more objects surrounding the bicycle based on the positioning of the bicycle, by at least one processor. The method also includes extracting, by the at least one processor, features of the bicycle, the cyclist, and the one or more objects from the sensor data. The method additionally includes predicting, by the at least one processor, the trajectory of the bicycle based on the extracted features using a learning model.

Embodiments of the disclosure further provide a non-transitory computer-readable medium having instructions stored thereon that, when executed by at least one processor, causes the at least one processor to perform operations. The operations include receiving a map of an area in which the bicycle is traveling and sensor data acquired associated with the bicycle. The operations further include positioning the bicycle in the map, identifying the cyclist riding the bicycle, and identifying one or more objects surrounding the bicycle based on the positioning of the bicycle. The operations also include extracting features of the bicycle, the cyclist, and the one or more objects from the sensor data. The operations additionally include predicting the trajectory of the bicycle based on the extracted features using a learning model.

It is to be understood that both the foregoing general description and the following detailed description are exemplary and explanatory only and are not restrictive of the invention, as claimed.

### BRIEF DESCRIPTION OF THE DRAWINGS

FIG. 1A illustrates a schematic diagram of an exemplary road segment including a bike lane to the right of vehicle lanes, according to embodiments of the disclosure.

FIG. 1B illustrates a schematic diagram of an exemplary road segment including a bike lane in the middle of two vehicle lanes, according to embodiments of the disclosure.

FIG. 1C illustrates a schematic diagram of an exemplary road segment including two bike lanes in opposite directions to the right of vehicle lanes, according to embodiments of the disclosure.

FIG. 2 illustrates a schematic diagram of an exemplary system for predicting a bicycle trajectory, according to embodiments of the disclosure.

FIG. 3 illustrates an exemplary vehicle with sensors equipped thereon, according to embodiments of the disclosure.

FIG. 4 is a block diagram of an exemplary server for predicting a bicycle trajectory, according to embodiments of the disclosure.

FIG. 5 is a flowchart of an exemplary method for predicting a bicycle trajectory, according to embodiments of the disclosure.

### DETAILED DESCRIPTION

Reference will now be made in detail to the exemplary embodiments, examples of which are illustrated in the accompanying drawings. Wherever possible, the same reference numbers will be used throughout the drawings to refer to the same or like parts.

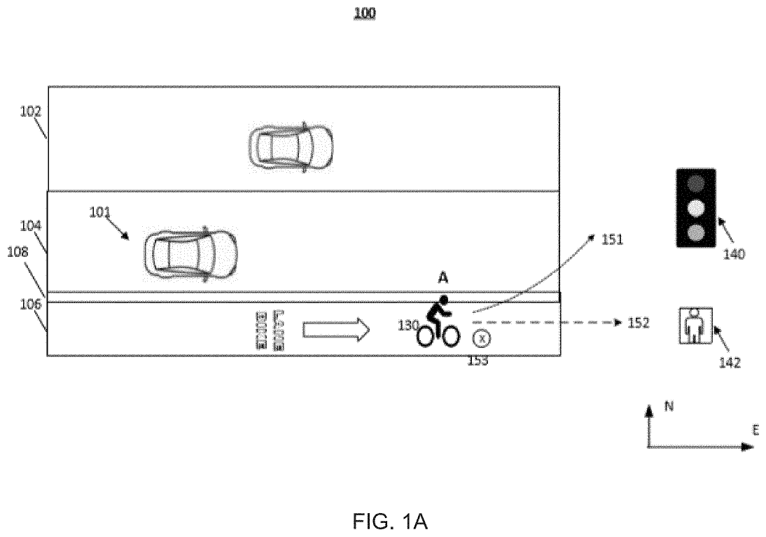

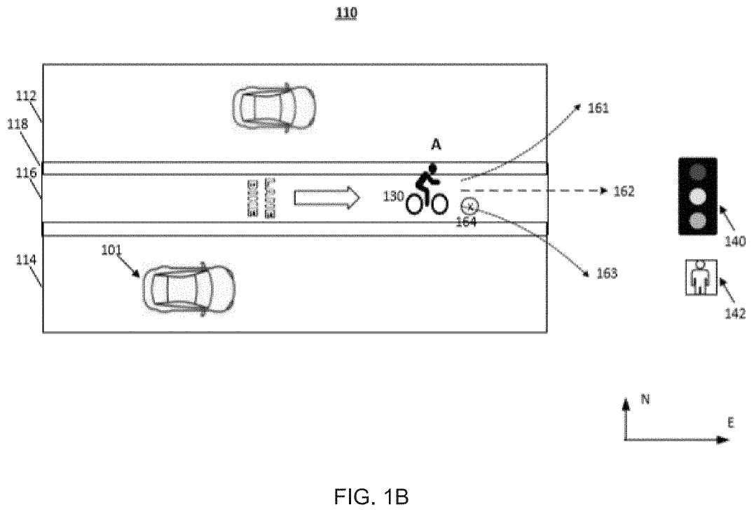

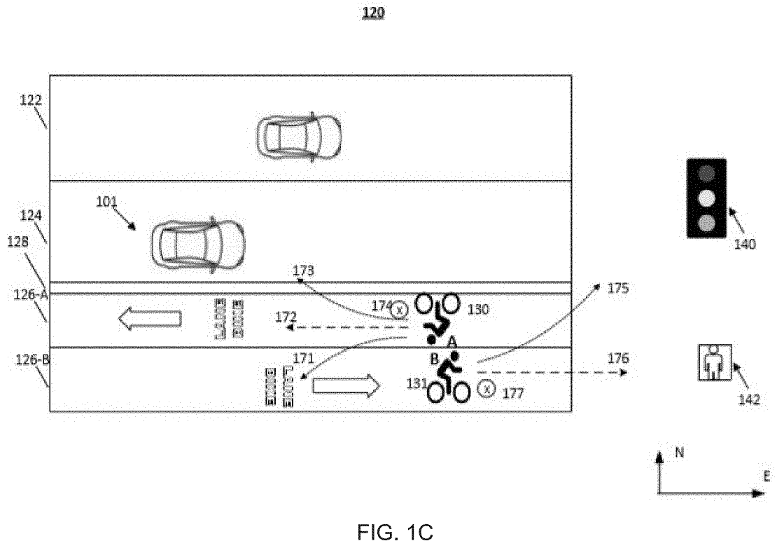

FIG. 1A illustrates a schematic diagram of an exemplary road segment 100 including a bike lane 106 to the right of vehicle lanes 102 and 104, according to embodiments of the disclosure. As shown in FIG. 1A, road segment 100 extending east-bound, facing traffic light 140 at a crossing. It is contemplated that road segment 100 can extend in any other directions, and is not necessarily adjacent to a traffic light.

Road segment 100 may be a part of a one-way or two-way road. For purpose of description, only two vehicle lanes in a single direction is shown in FIG. 1A. However, it is contemplated that road segment 100 may include more or less vehicle lanes, and the vehicle lanes can be in both directions opposite to each other and separated by a divider. As shown in FIG. 1A, road segment 100 includes vehicle lanes 102 and 104, and a bike lane 106 to the right of vehicle lane 104. In some embodiments, bike lane 106 may be separated from vehicle lane 104 by a divider 108, such as a guardrail, a fence, a plant strip, or a no-entry zone. In some embodiments, bike lane 106 may not be separated from vehicle lane 104, or separated only by a line marking.

Various vehicles may be traveling on vehicle lanes 102 and 104. For example, vehicle 101 may be traveling east-bound on vehicle lane 104. In some embodiments, vehicle 101 may be an electric vehicle, a fuel cell vehicle, a hybrid vehicle, or a conventional internal combustion engine vehicle. In some embodiments, vehicle 101 may be an autonomous or semi-autonomous vehicle.

Various bicycles may be traveling on bike lane 106. For example, bicycle 130, ridden by cyclist A, may be traveling east-bound on bike lane 106. Consistent with the present disclosure, a “bicycle” may be a mechanical bike, an electric bike, a scooter, a hoverboard, a Segway™, or any transportation tool that is not a motorized vehicle and allowed on bike lane 106. In some embodiments, bike lane 106 may be marked with a lane marking to indicate it is a bike lane. For example, the words “bike lane” may be marked, and/or a directional arrow pointing to the intended traffic direction are marked on bike lane 106, as shown in FIG. 1A. In another example, a bicycle icon alternative or in additional to the words may be marked on bike lane 106.

Traffic of vehicles and bicycles on road segment 100 may be regulated by traffic light 140 and a pedestrian traffic light 142. For example, traffic light 140 may regulate the vehicle traffic and pedestrian traffic light 142 may regulate the pedestrian and bicycle traffic. In some embodiments, traffic light 140 may include lights in three colors: red, yellow and green, to signal the right of way at cross-road 100. In some embodiments, traffic light 140 may additionally include turn protection lights to regulate the left, right, and/or U-turns at cross-road 100. For example, a left turn protection light may allow vehicles in certain lanes (usually the left-most lane) to turn left without having to yield to vehicles traveling straight in the opposite direction. Pedestrian traffic light 142 may switch between two modes: a “walk” mode and “do not walk” mode. Depending on the design, pedestrian traffic light 142 may show different words or icons to indicate the modes. For example, pedestrian traffic light 142 may show a pedestrian icon when pedestrians and bicycles are allowed to cross, and a hand icon to stop the same traffic. In some embodiments, pedestrian traffic light 142 may additionally use different colors, sounds (e.g., beeping sounds), and/or flashing to indicate the modes.

It is contemplated that bicycle 130 may routinely turn at places that are not regulated by traffic lights. For example, bicycle 130 may turn left in order to enter a bike trail on the left hand of the road. In that case, cyclist A may typically make a hand signal to the vehicles before getting into a vehicle lane. For example, cyclist A may point his left arm to the left to signal a left-turn. Cyclist A may raise his left arm up or point his right arm to the right to signal a right-turn. Cyclist A may point his left arm down or put his right hand behind his waist to signal he plans to make a stop.

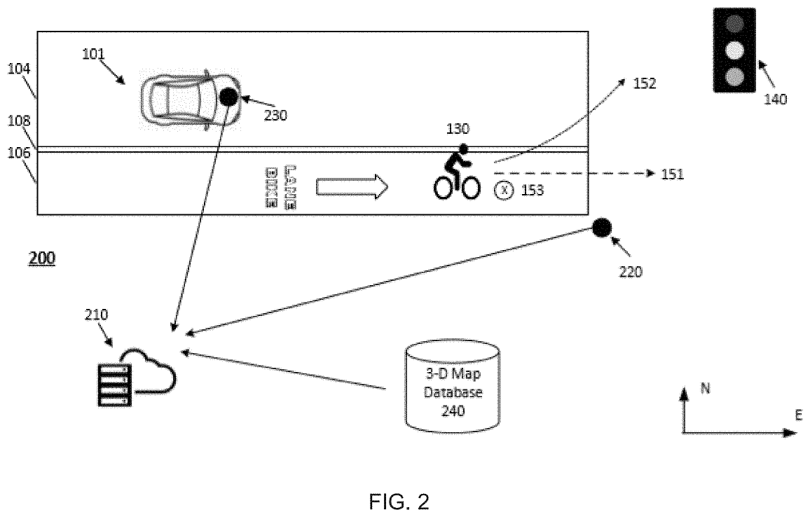

In some embodiments, vehicle 101 may be equipped with or in communication with a bicycle trajectory prediction system (e.g., system 200 shown in FIG. 2) to predict the trajectory of a bicycle, such as bicycle 130, in order to make decisions to avoid that bicycle in its own travel path. For example, in the setting of FIG. 1A, bicycle 130 may possibly travel in three candidate trajectories: a candidate trajectory 151 to make a left-turn, a candidate trajectory 152 to go straight, a candidate trajectory 153 to make a stop. Candidate trajectory 151 may potentially interfere with vehicle 101's driving path. Consistent with embodiments of the present disclosure, the bicycle trajectory prediction system may make “observations” (e.g., through various sensors) of bicycle 130, cyclist A riding bicycle 130, and the surrounding objects, such as traffic light 140, pedestrian traffic light 412, and any traffic sign along road segment 100. The bicycle trajectory prediction system then makes a prediction which candidate trajectory bicycle 130 may likely follow based on these observations. In some embodiments, the prediction may be preformed using a learning model, such as a neural network. In some embodiments, probabilities may be determined for the respective candidate trajectories 151-153.

FIG. 1B illustrates a schematic diagram of an exemplary road segment 110 including a bike lane 116 in the middle of two vehicle lanes 112 and 114, according to embodiments of the disclosure. Similar to road segment 100, road segment 110 may also be part of a one-way or two-way road and may include more or less lanes than those shown in FIG. 1B. Vehicle lanes 112 and 114 and bike lane 116 are similar to vehicles 102 and 104 and bike lane 106 described in connection with FIG. 1A. Unlike bike lane 106 that is located to the right of the right-most vehicle lanes, bike lane 116 positions between two vehicle lanes 112 and 114. Bike lane 116 may be separated from each vehicle lane by a divider 118. The vehicle traffic and bicycle traffic may be regulated by traffic light 140 and pedestrian traffic light 142, in a similar manner as described in connection with FIG. 1A.

In the setting of FIG. 1B, bicycle 130 may possibly travel in four candidate trajectories: a candidate trajectory 161 to make a left-turn, a candidate trajectory 162 to go straight, a candidate trajectory 163 to make a right-turn, and a candidate trajectory 164 to make a stop. Candidate trajectory 163 may potentially interfere with vehicle 101's driving path. Consistent with embodiments of the present disclosure, the bicycle trajectory prediction system may make a prediction which candidate trajectory bicycle 130 may likely follow based on observations made (e.g., through various sensors) of bicycle 130, cyclist A riding bicycle 130, and the surrounding objects, such as traffic light 140, pedestrian traffic light 412, and any traffic sign along road segment 100.

FIG. 1C illustrates a schematic diagram of an exemplary road segment 120 including two bike lanes 126-A and 126-B in opposite directions to the right of vehicle lanes 122 and 124, according to embodiments of the disclosure. Again, similar to road segment 100, road segment 120 may also be part of a one-way or two-way road and may include more or less lanes than those shown in FIG. 1C. Vehicle lanes 122 and 124 are similar to vehicles 102 and 104 described in connection with FIG. 1A. Unlike road segment 100 that has a single bike lane 106 that is located to the right of vehicle lane 104, road segment 100 has two bike lanes 126-A and 126-B in the opposite directions of each other and both located to the right of vehicle lane 124. Bike lane 126-A adjacent to vehicle lane 124 may be separated from the vehicle lane by a divider 128.

Unlike bike lane 106 that extends in the same direction as vehicle lane 104, bike lane 126-A goes in the opposite direction as vehicle lane 124. As shown in FIG. 1C, cyclist A may be riding bicycle 130 in the west-bound direction on bike lane 126-A, and cyclist B may be riding bicycle 131 in the east-bound direction on bike lane 126-B. As a result, bicycle 130 and vehicle 101 face each other in the directions they travel. The vehicle traffic and bicycle traffic may be regulated by traffic light 140 and pedestrian traffic light 142, in a similar manner as described in connection with FIG. 1A.

In the setting of FIG. 1C, bicycle 130 may possibly travel in four candidate trajectories: a candidate trajectory 171 to make a left-turn, a candidate trajectory 172 to go straight, a candidate trajectory 173 to make a right-turn, and a candidate trajectory 174 to make a stop. Bicycle 131 may possibly travel in three candidate trajectories: a candidate trajectory 175 to make a left-turn, a candidate trajectory 176 to go straight, and a candidate trajectory 177 to make a stop. Candidate trajectory 173 and candidate trajectory 175 may potentially interfere with vehicle 101's driving path. Consistent with embodiments of the present disclosure, the bicycle trajectory prediction system may make a prediction which candidate trajectories bicycles 130 and 131 may likely follow based on observations made (e.g., through various sensors) of bicycles 130-131, cyclist A and B riding bicycles 130-131, and the surrounding objects, such as traffic light 140, pedestrian traffic light 412, and any traffic sign along road segment 100.

FIG. 2 illustrates a schematic diagram of an exemplary system 200 for predicting a bicycle trajectory, according to embodiments of the disclosure. For ease of illustration, the road setting of FIG. 1A is used as an example. However, it is understood that system 200 is also applicable in other road settings, such as those shown in FIG. 1B and FIG. 1C. System 200 may include a bicycle trajectory prediction server 210 (also referred to as server 210 for simplicity). Server 210 can be a general-purpose server configured or programmed to predict bicycle trajectories or a proprietary device specially designed for predicting bicycle trajectories. It is contemplated that server 210 can be a stand-alone server or an integrated component of a stand-alone server. In some embodiments, server 210 may be integrated into a system onboard a vehicle, such as vehicle 101.

As illustrated in FIG. 2, server 210 may receive and analyze data collected by various sources. For example, data may be continuously, regularly, or intermittently captured by one or more sensors 220 equipped along a road and/or one or more sensors 230 equipped on vehicle 101 driving through lane 104. Sensors 220 and 230 may include radars, LiDARs, cameras (such as surveillance cameras, monocular/binocular cameras, video cameras), speedometers, or any other suitable sensors to capture data characterizing bicycle 130, cyclist A riding bicycle 130, and objects surrounding bicycle 130, such as traffic light 140 and pedestrian traffic light 142. For example, sensors 220 may include one or more surveillance cameras that capture images of bicycle 130 and traffic lights 140-142.

In some embodiments, sensors 230 may include a LiDAR that measures a distance between vehicle 101 and bicycle 130, and determines the position of bicycle 130 in a 3-D map. In some embodiments, sensor 230 may also include a GPS/IMU (inertial measurement unit) sensor to capture position/pose data of vehicle 101. In some embodiments, sensors 230 may additionally include cameras to capture images of bicycle 130 including cyclist A riding the bicycle and traffic lights 140-142. Since the images captured by sensors 220 and sensors 230 are from different angles, they may supplement each other to provide more detailed information of bicycle 130, cyclist A, and surrounding objects. In some embodiments, sensors 220 and 230 may acquire data that tracks the trajectories of moving objects, such as vehicles, bicycles, pedestrians, etc.

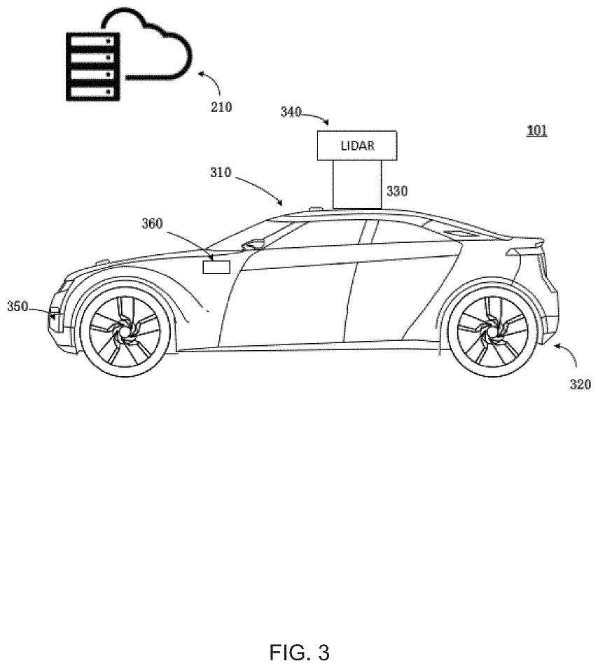

In some embodiments, sensors 230 may be equipped on vehicle 101 and thus travel with vehicle 101. For example, FIG. 3 illustrates an exemplary vehicle 101 with sensors 340-360 equipped thereon, according to embodiments of the disclosure. Vehicle 101 may have a body 310, which may be any body style, such as a sports vehicle, a coupe, a sedan, a pick-up truck, a station wagon, a sports utility vehicle (SUV), a minivan, or a conversion van. In some embodiments, vehicle 101 may include a pair of front wheels and a pair of rear wheels 320, as illustrated in FIG. 3. However, it is contemplated that vehicle 101 may have less wheels or equivalent structures that enable vehicle 101 to move around. Vehicle 101 may be configured to be all wheel drive (AWD), front wheel drive (FWR), or rear wheel drive (RWD). In some embodiments, vehicle 101 may be configured to be an autonomous or semi-autonomous vehicle.

As illustrated in FIG. 3, sensors 230 of FIG. 2 may include various kinds of sensors 340, 350, and 360, according to embodiments of the disclosure. Sensor 340 may be mounted to body 310 via a mounting structure 330. Mounting structure 330 may be an electro-mechanical device installed or otherwise attached to body 310 of vehicle 101. In some embodiments, mounting structure 330 may use screws, adhesives, or another mounting mechanism. Vehicle 101 may be additionally equipped with sensors 350 and 360 inside or outside body 310 using any suitable mounting mechanisms. It is contemplated that the manners in which sensors 340-360 can be equipped on vehicle 101 are not limited by the example shown in FIG. 3 and may be modified depending on the types of sensors 340-360 and/or vehicle 101 to achieve desirable sensing performance.

Consistent with some embodiments, sensor 340 may be a LiDAR that measures the distance to a target by illuminating the target with pulsed laser lights and measuring the reflected pukes. Differences in laser return times and wavelengths can then be used to make digital 3-D representations of the target. For example, sensor 340 may measure the distance between vehicle 101 and bicycle 130 or other objects. The light used for LiDAR scan may be ultraviolet, visible, or near infrared. Because a narrow laser beam can map physical features a very high resolution, a LiDAR scanner is particularly suitable for positioning objects in a 3-D map. For example, a LiDAR scanner may capture point cloud data, which may be used to position vehicle 101, bicycle 130, and/or other objects.

In some embodiments, sensors 350 may include one or more cameras mounted on body 310 of vehicle 101. Although FIG. 3 shows sensors 350 as being mounted at the front of vehicle 101, it is contemplated that sensors 350 may be mounted or installed at other positions of vehicle 101, such as on the sides, behind the mirrors, on the windshields, on the racks, or at the rear end. Sensors 350 may be configured to capture images of objects surrounding vehicle 101, such as bicycles on the roads (including, e.g., bicycle 130 and cyclist A riding it), traffic lights (e.g., 140 and 142), and/or traffic signs. In some embodiments, the cameras may be monocular or binocular cameras. The binocular cameras may acquire data indicating depths of the objects (i.e., the distances of the objects from the cameras). In some embodiments, the cameras may be video cameras that capture image frames over time, thus recording the movements of the objects.

As illustrated in FIG. 3, vehicle 101 may be additionally equipped with sensor 360, which may include sensors used in a navigation unit, such as a GPS receiver and one or more IMU sensors. A GPS is a global navigation satellite system that provides geolocation and time information to a GPS receiver. An IMU is an electronic device that measures and provides a vehicle's specific force, angular rate, and sometimes the magnetic field surrounding the vehicle, using various inertial sensors, such as accelerometers and gyroscopes, sometimes also magnetometers. By combining the GPS receiver and the IMU sensor, sensor 360 can provide real-time pose information of vehicle 101 as it travels, including the positions and orientations (e.g., Euler angles) of vehicle 101 at each time point.

Consistent with the present disclosure, sensors 340-360 may communicate with server 210 via a network to transmit the sensor data continuously, or regularly, or intermittently. In some embodiments, any suitable network may be used for the communication, such as a Wireless Local Area Network (WLAN), a Wide Area Network (WAN), wireless communication networks using radio waves, a cellular network, a satellite communication network, and/or a local or short-range wireless network (e.g., Bluetooth™).

Referring back to FIG. 2, system 200 may further include a 3-D map database 240. 3-D map database 240 may store 3-D maps. The 3-D maps may include maps that cover different regions and areas. For example, a 3-D map (or map portion) may cover the area of cross-road 100. In some embodiments, server 210 may communicate with 3-D map database 240 to retrieve a relevant 3-D map (or map portion) based on the position of vehicle 101. For example, map data containing the GPS position of vehicle 101 and its surrounding area may be retrieved. In some embodiments, 3-D map database 240 may be an internal component of server 210. For example, the 3-D maps may be stored in a storage of server 210. In some embodiments, 3-D map database 240 may be external of server 210 and the communication between 3-D map database 240 and server 210 may occur via a network, such as the various kinds of networks described above.

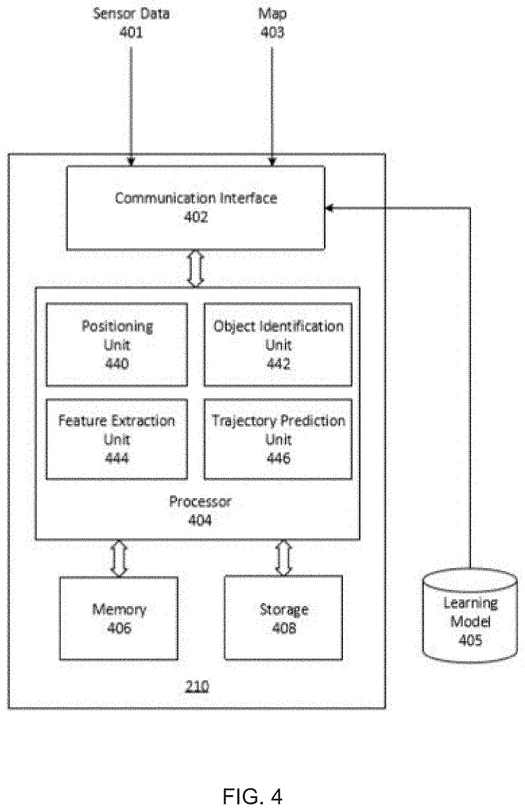

Server 210 may be configured to analyze the sensor data received from sensors 230 (e.g., sensors 340-360) and the map data received from 3-D map database 240 to predict the trajectories of bicycles, such as bicycle 130. FIG. 4 is a block diagram of an exemplary server 210 for predicting a bicycle trajectory, according to embodiments of the disclosure. Server 210 may include a communication interface 402, a processor 404, a memory 406, and a storage 408. In some embodiments, server 210 may have different modules in a single device, such as an integrated circuit (IC) chip (implemented as an application-specific integrated circuit (ASIC) or a field-programmable gate array (FPGA)), or separate devices with dedicated functions. Components of server 210 may be in an integrated device, or distributed at different locations but communicate with each other through a network (not shown).

Communication interface 402 may send data to and receive data from components such as sensors 220 and 230 via direct communication links, a Wireless Local Area Network (WLAN), a Wide Area Network (WAN), wireless communication networks using radio waves, a cellular network, and/or a local wireless network (e.g., Bluetooth™ or WiFi), or other communication methods. In some embodiments, communication interface 402 can be an integrated services digital network (ISDN) card, cable modem, satellite modem, or a modem to provide a data communication connection. As another example, communication interface 402 can be a local area network (LAN) card to provide a data communication connection to a compatible LAN. Wireless links can also be implemented by communication interface 402. In such an implementation, communication interface 402 can send and receive electrical, electromagnetic or optical signals that carry digital data streams representing various types of information via a network.

Consistent with some embodiments, communication interface 402 may receive sensor data 401 acquired by sensors 220 and/or 230, as well as map data 403 provided by 3-D map database 240, and provide the received information to memory 406 and/or storage 408 for storage or to processor 404 for processing. Sensor data 401 may include information capturing bicycles (such as bicycle 130), the cyclists riding the bicycles, and other objects surrounding the bicycles. Sensor data 401 may contain data captured over time that characterize the movements of the objects. In some embodiments, map data 403 may include point cloud data.

Communication interface 402 may also receive a learning model 405. In some embodiments, learning model 405 may be applied by processor 404 to predict bicycle trajectories based on features extracted from sensor data 401 and map data 403. In some embodiments, learning model 405 may be a predictive model, such as a decision tree learning model or a logistic regression model. A decision tree uses observations of an item (represented in the branches) to predict a target value of the item (represented in the leaves). For example, a decision tree model may predict the probabilities of several hypothetical outcomes, e.g., probabilities of the candidate trajectories of bicycle 130. In some embodiments, gradient boosting may be combined with the decision tree learning model to form a prediction model as an ensemble of decision trees. For example, learning model 405 may become a Gradient Boosting Decision Tree model formed with stage-wise decision trees. In some embodiments, learning model may be a logistic regression model that predicts values of a discrete variable. For example, a logistic regression model may be used to rank several hypothetical outcomes, e.g., to rank the candidate trajectories of bicycle 130.

In some embodiments, learning model 405 may be trained using known bicycle trajectories and their respective sample features, such as semantic features including the bicycle speed, the orientation of the bicycle, the hand signals of the cyclist riding the bicycle, the lane markings of bike lane, status of the pedestrian traffic light, the type of divider between the bike lane and the vehicle lane, etc. The sample features may additionally include non-semantic features extracted from data descriptive of the bicycle movements. In some embodiments, learning model 405 may be trained by server 210 or another computer/server ahead of time.

Processor 404 may include any appropriate type of general-purpose or special-purpose microprocessor, digital signal processor, or microcontroller. Processor 404 may be configured as a separate processor module dedicated to predicting bicycle trajectories. Alternatively, processor 404 may be configured as a shared processor module for performing other functions related to or unrelated to bicycle trajectory predictions. For example, the shared processor may further make autonomous driving decision based on the predicted bicycle trajectories.

As shown in FIG. 4, processor 404 may include multiple modules, such as a positioning unit 440, an object identification unit 442, a feature extraction unit 444, a trajectory prediction unit 446, and the like. These modules (and any corresponding sub-modules or sub-units) can be hardware units (e.g., portions of an integrated circuit) of processor 404 designed for use with other components or to execute part of a program. The program may be stored on a computer-readable medium (e.g., memory 406 and/or storage 408), and when executed by processor 404, it may perform one or more functions. Although FIG. 4 shows units 440-446 all within one processor 404, it is contemplated that these units may be distributed among multiple processors located near or remotely with each other.

Positioning unit 440 may be configured to position the bicycle whose trajectory is being predicted (e.g., bicycle 130) in map data 403. In some embodiments, sensor data 401 may contain various data captured of the bicycle to assist the positioning. For example, LiDAR data captured by sensor 340 mounted on vehicle 101 may reveal the position of bicycle 130 in the point cloud data. In some embodiments, the point cloud data captured of bicycle 130 may be matched with map data 401 to determine the bicycle's position. In some embodiments, positioning methods such as simultaneous localization and mapping (SLAM) may be used to position the bicycle.

In some embodiments, the positions of the bicycle (e.g., bicycle 130) may be labeled on map data 401. For example, a subset of point cloud data P₁ is labeled as corresponding to bicycle 130 at time T₁, a subset of point cloud data P₂ is labeled as corresponding to bicycle 130 at time T₂, and a subset of point cloud data P₃ is labeled as corresponding to bicycle 130 at time T₃, etc. The labeled subsets indicate the existing moving trajectory and moving speed of the bicycle.

Object identification unit 442 may identify the cyclist riding the bicycle, e.g., cyclist A riding bicycle 130. Object identification unit 442 may further identify objects surrounding the bicycle. These objects may include, e.g., traffic light 140, pedestrian traffic light 142, traffic signs, lane markings, divider 108, and other vehicles, etc. In some embodiments, various image processing methods, such as image segmentation, classification, and recognition method, may be applied to identify the cyclist and objects. In some embodiments, machine learning techniques may also be applied for the identification. The cyclist and the objects may provide additional information useful to the bicycle trajectory prediction. For example, the cyclist may use hand signals to indicate the intended trajectory of the bicycle he is riding. As another example, if the bicycle is traveling at a high speed, it is less likely that it is going to stop suddenly. Alternatively, if the pedestrian traffic light regulating the bike lane instructs not to go across, the bicycle will likely not move immediately.

Feature extraction unit 444 may be configured to extract features from sensor data 401 and map data 403 that are indicative of a future trajectory of a bicycle. The features extracted may be semantical or non-semantical. Semantical features may include, e.g., the bicycle speed, the bicycle heading direction, the lane markings of bike lane, the status of the pedestrian traffic light, the cyclist hand signals, and the type of divider between the bike lane and the vehicle lane, etc. Various feature extraction tools may be used, such as image segmentation, object detection, etc. For example, the cyclist may be identified as an object that moves with the bicycle at the same speed. Gesture detection methods can then be applied to detect the movement of the cyclist's arm. As another example, lane markings can be detected from the sensor data based on color and/or contrast information as the markings are usually in white paint and road surface is usually black or gray in color. When color information is available, lane markings can be identified based on their distinct color (e.g., white). When grayscale information is available, lane markings can be identified based on their different shading (e.g., lighter gray) in contrast to the background (e.g., darker gray for regular road pavements). As another example, traffic light signals can be detected by detecting the change (e.g., resulting from blinking, flashing, or color changing) in image pixel intensities. In some embodiments, machine learning techniques may also be applied to extract the feature(s).

Trajectory prediction unit 446 may predict the bicycle trajectory using the extracted features. In some embodiments, trajectory prediction unit 446 may determine a plurality of candidate trajectories, such as candidate trajectories 151-153 for bicycle 130 (shown in FIG. 1A). In some embodiments, trajectory prediction unit 446 may apply learning model 405 for the prediction. For example, learning model 405 may determine a probability for each candidate trajectory based on the extracted features. Alternatively, learning model 405 may rank the candidate trajectories by assigning ranking numbers to them. In some embodiments, the candidate trajectory with the highest probability or ranking may be identified as the predicted trajectory of the bicycle.

In some embodiments, before applying learning model 405, trajectory prediction unit 446 may first remove one or more candidate trajectories that conflicts with any of the features. For example, if the cyclist makes a hand signal to indicate he will turn left, a right-turn trajectory may be eliminated since the probably that the bicycle will turn right is substantially low. As another example, if the divider between the bike lane on which the bicycle is traveling is a fence or plant strip, the left-turn trajectory may be eliminated. By removing certain candidate trajectories, trajectory prediction unit 446 simplifies the prediction task and conserves processing power of processor 404.

In some embodiments, trajectory prediction unit 446 may compare the determined probabilities for the respective candidate trajectories with a threshold. If none of the candidate trajectory has a probability exceeding the threshold, trajectory prediction unit 446 may determine that the prediction is not sufficiently reliable and additional “observations” are necessary to improve the prediction. In some embodiments, trajectory prediction unit 446 may determine what additional sensor data can be acquired and generate control signals to be transmitted to sensors 220 and/or 230 for capturing the additional data. For example, it may be determined that the LiDAR should be tilted at a different angle or that the camera should adjust its focal point. The control signal may be provided to sensors 220 and/or 230 via communication interface 402.

Memory 406 and storage 408 may include any appropriate type of mass storage provided to store any type of information that processor 404 may need to operate. Memory 406 and storage 408 may be a volatile or non-volatile, magnetic, semiconductor, tape, optical, removable, non-removable, or other type of storage device or tangible (i.e., non-transitory) computer-readable medium including, but not limited to, a ROM, a flash memory, a dynamic RAM, and a static RAM. Memory 406 and/or storage 408 may be configured to store one or more computer programs that may be executed by processor 404 to perform bicycle trajectory functions disclosed herein. For example, memory 406 and/or storage 408 may be configured to store program(s) that may be executed by processor 404 to predict the bicycle trajectory based on features extracted from the sensor data 401 captured by various sensors 220 and/or 230, and map data 403.

Memory 406 and/or storage 408 may be further configured to store information and data used by processor 404. For instance, memory 406 and/or storage 408 may be configured to store sensor data 401 captured by sensors 220 and/or 230, map data 403 received from 3-D map database 240, and learning model 405. Memory 406 and/or storage 408 may also be configured to store intermediate data generated by processor 404 during feature extraction and trajectory prediction, such as the features, the candidate trajectories, and the calculated probabilities for the candidate trajectories. The various types of data may be stored permanently, removed periodically, or disregarded immediately after each frame of data is processed.

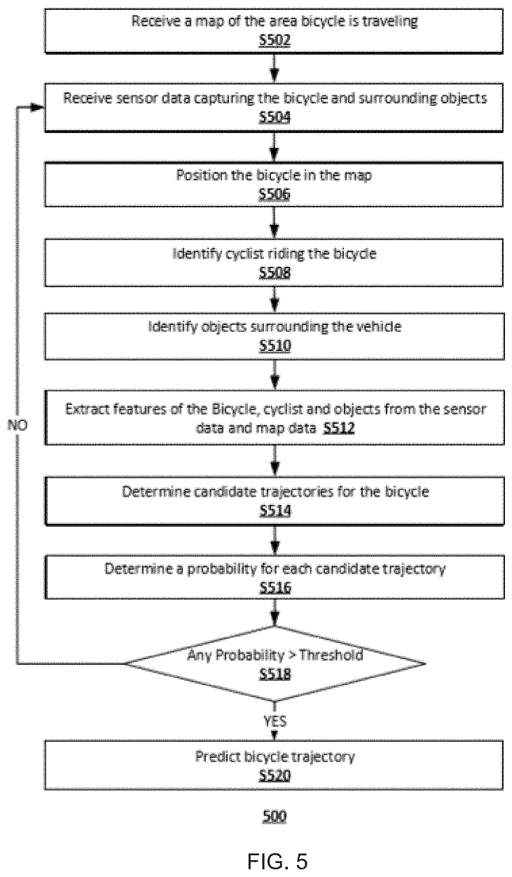

FIG. 5 illustrates a flowchart of an exemplary method 500 for predicting a bicycle trajectory, according to embodiments of the disclosure. For example, method 500 may be implemented by system 200 that includes, among other things, server 210 and sensors 220 and 230. However, method 500 is not limited to that exemplary embodiment. Method 500 may include steps S502-S520 as described below. It is to be appreciated that some of the steps may be optional to perform the disclosure provided herein. Further, some of the steps may be performed simultaneously, or in a different order than shown in FIG. 5. For description purpose, method 500 will be described as predicting the trajectory of bicycle 130 (as shown in FIGS. 1A-1C) to aid autonomous driving decisions of vehicle 101 (as shown in FIGS. 1A-1C). Method 500, however, can be implemented for other applications that can benefit from accurate predictions of bicycle trajectories.

In step S502, server 210 receives a map of the area bicycle 130 is traveling. In some embodiments, server 210 may determine the position of vehicle 101 based on, e.g., the GPS data collected by sensor 360, and identify a map area surrounding the position. Server 210 may receive the relevant 3-D map data, e.g., map data 403, from 3-D map database 240.

In step S504, server 210 receives the sensor data capturing bicycle 130 and surrounding objects. In some embodiments, the sensor data may be captured by various sensors such as sensors 220 installed along the roads and/or sensors 230 (including, e.g., sensors 340-360) equipped on vehicle 101. The sensor data may include bicycle speed acquired by a speedometer, images (including video images) acquired by cameras, point cloud data acquired by a LiDAR, etc. In some embodiments, the sensor data may be captured over time to track the movement of bicycle 130 and surrounding objects. The sensors may communicate with server 210 via a network to transmit the sensor data, e.g., sensor data 401, continuously, or regularly, or intermittently.

Method 500 proceeds to step S506, where server 210 positions bicycle 130 in the map. In some embodiments, the point cloud data captured of bicycle 130, e.g., by sensor 340, may be matched with map data 403 to determine the bicycle's position in the map. In some embodiments, positioning methods such as SLAM may be used to position bicycle 130. In some embodiments, the positions of bicycle 130 at different time points may be labeled on map data 403 to trace the prior trajectory and moving speed of the bicycle. Labeling of the point cloud data may be performed by server 210 automatically or with human assistance.

In step S508, server 210 identifies the cyclist riding the bicycle. In step S510, server 210 identifies other objects surrounding bicycle 130. For example, these objects may include, e.g., traffic lights 140 and 142, divider 108, traffic signs, and lane markings, etc. Features of the cyclist and such objects may provide additional information useful for predicting the trajectory of bicycle 130. In some embodiments, various image processing methods and machine learning methods may be implemented to identify the cyclist and objects.

In step S512, server 210 extracts features of bicycle 130, cyclist A riding the bicycle, and surrounding objects from sensor data 401 and map data 403. In some embodiments, the features extracted may include semantical or non-semantical that are indicative of future trajectory of the bicycle. For example, extracted features of bicycle 130 may include, e.g., the bicycle speed, and the bicycle heading direction, etc. Extracted features of the cyclist may include hand signals. Extracted features of surrounding objects may include, e.g., the lane markings of bike lane, the status of the traffic lights, the type of divider between the bike lane and the vehicle lane, and information on the traffic signs. In some embodiments, various feature extraction methods including image processing methods and machine learning methods may be implemented.

In step S514, server 210 determines multiple candidate trajectories for bicycle 130. Candidate trajectories are possible trajectories bicycle 130 may follow. For example, bicycle 130 may follow one of the four candidate trajectories 151-153 (shown in FIG. 1A), i.e., to turn left, go straight, or make a stop. In some embodiments, server 210 may remove one or more candidate trajectories that conflicts with any of the features. This optional filtering step may help simplify the prediction task and conserve processing power of server 210. For example, if the cyclist makes a hand signal to indicate he will turn left, a right-turn trajectory may be eliminated since the probably that the bicycle will turn right is substantially low.

Method 500 proceeds to step S516 to determine a probability for each candidate trajectory. In some embodiments, server 210 may apply learning model 405 for the prediction. In some embodiments, learning model 405 may be a predictive model, such as a decision tree learning model or a logistic regression model. For example, learning model 405 may be a Gradient Boosting Decision Tree model. In some embodiments, learning model 405 may be trained using known bicycle trajectories and their respective sample features.

In step S516, learning model 405 may be applied to determine a probability for each candidate trajectory based on the extracted features. For example, it may be determined that bicycle 130 has a 10% probability to follow candidate trajectory 151 to make a left-turn, 50% probability to follow candidate trajectory 152 to go straight, 40% probability to follow candidate trajectory 153 to make a stop.

In step S518, server 210 may compare the probabilities with a predetermined threshold. In some embodiments, the predetermined threshold may be a percentage higher than 50%, such as 60%, 70%, 80%, or 90%. If no probability is higher than the threshold (S518: No), the prediction may be considered unreliable. In some embodiments, method 500 may return to step S504 to receive additional sensor data to improve the prediction. In some embodiments, server 210 may determine what additional sensor data can be acquired and generate control signals to direct sensors 220 and/or 230 to capture the additional data to be received in step S504.

If at least the highest probability is higher than the threshold (S518: Yes), server 210 may predict the bicycle trajectory in step S520 by selecting the corresponding candidate trajectory from the candidate trajectories. In some embodiments, the candidate trajectory with the highest probability may be identified as the predicted trajectory of the bicycle. For example, candidate trajectory 152 may be selected as the predicted trajectory of bicycle 130 when it has the highest probability.

The prediction result provided by method 500 may be used to aid vehicle controls or driver's driving decisions. For example, an autonomous vehicle may make automated control decisions based on the predicted trajectories of bicycles in order not to collide with them. The prediction may also be used to help alerting a driver to adjust his intended driving path and/or speed to avoid collision. For example, audio alerts such as beeping may be provided.

Another aspect of the disclosure is directed to a non-transitory computer-readable medium storing instructions which, when executed, cause one or more processors to perform the methods, as discussed above. The computer-readable medium may include volatile or non-volatile, magnetic, semiconductor, tape, optical, removable, non-removable, or other types of computer-readable medium or computer-readable storage devices. For example, the computer-readable medium may be the storage device or the memory module having the computer instructions stored thereon, as disclosed. In some embodiments, the computer-readable medium may be a disc or a flash drive having the computer instructions stored thereon.

It will be apparent to those skilled in the art that various modifications and variations can be made to the disclosed system and related methods. Other embodiments will be apparent to those skilled in the art from consideration of the specification and practice of the disclosed system and related methods.

It is intended that the specification and examples be considered as exemplary only, with a true scope being indicated by the following claims and their equivalents.

What is claimed is:

1. A system for predicting a trajectory of a bicycle ridden by a cyclist, comprising:
a communication interface configured to receive a map of an area in which the bicycle is traveling and sensor data acquired associated with the bicycle; and
at least one processor configured to:
position the bicycle in the map;
identify the cyclist riding the bicycle;
identify one or more objects surrounding the bicycle based on the positioning of the bicycle;
extract features of the bicycle, the cyclist, and the one or more objects from the sensor data; and
predict the trajectory of the bicycle based on the extracted features using a learning model.

2. The system of claim 1, wherein to predict the trajectory of the bicycle, the at least one processor is further configured to:
determine a plurality of candidate trajectories;
determine a probability for each candidate trajectory based on the extracted features using the learning model; and
identify the candidate trajectory with the highest probability as the predicted trajectory of the bicycle.

3. The system of claim 2, wherein the at least one processor is further configured to:
request additional sensor data acquired associated with the bicycle when the highest probability is lower than a predetermined threshold.

4. The system of claim 1, wherein to predict the trajectory of the bicycle the at least one processor is further configured to:
rank the plurality of candidate trajectories based on the extracted features using the learning model; and
identify the candidate trajectory with the highest rank as the predicted trajectory of the bicycle.

5. The system of claim 1, wherein the learning model is a decision tree model or a logistic regression model.

6. The system of claim 1, wherein the sensor data includes point cloud data acquired by a LiDAR and images acquired by a camera.

7. The system of claim 1, wherein to extract features of the cyclist, the at least one processor is further configured to detect a hand signal of the cyclist.

8. The system of claim 1, wherein the one or more objects include a pedestrian traffic light that the bicycle is facing, wherein to extract features of the one or more objects, the at least one processor is further configured to determine a status of the pedestrian traffic light.

9. The system of claim 1, wherein the one or more objects include a bike lane that the bicycle is following, wherein to extract features of the one or more objects, the at least one processor is further configured to detect a direction and a pathway of the bike lane.

10. The system of claim 1, wherein to extract features of the cyclist, the at least one processor is further configured to determine a speed of the bicycle.

11. The system of claim 2, wherein the at least one processor is further configured to:
remove a candidate trajectory that conflicts with any of the features before determining the probability for each candidate trajectory.

12. The system of claim 1, wherein the sensor data are acquired by at least one sensor equipped on a vehicle traveling in the area that the bicycle is traveling in, wherein the communication interface is further configured to provide the predicted trajectory of the bicycle to the vehicle.

13. A method for predicting a trajectory of a bicycle ridden by a cyclist, comprising:
receiving, by a communication interface, a map of an area in which the bicycle is traveling and sensor data acquired associated with the bicycle;
positioning, by at least one processor, the bicycle in the map;
identifying, by the at least one processor, the cyclist riding the bicycle;
identifying, by the at least one processor, one or more objects surrounding the bicycle based on the positioning of the bicycle;
extracting, by the at least one processor, features of the bicycle, the cyclist, and the one or more objects from the sensor data; and
predicting, by the at least one processor, the trajectory of the bicycle based on the extracted features using a learning model.

14. The method of claim 13, wherein predicting the trajectory of the bicycle further comprises:
determining a plurality of candidate trajectories;
determining a probability for each candidate trajectory based on the extracted features using the learning model; and
identifying the candidate trajectory with the highest probability as the predicted trajectory of the bicycle.

15. The method of claim 13, wherein the learning model is a decision tree model or a logistic regression model.

16. The method of claim 13, wherein the sensor data includes point cloud data acquired by a LiDAR and images acquired by a camera.

17. The method of claim 13, wherein extracting features further comprises:
detecting a hand signal of the cyclist;
determining a status of a pedestrian traffic light that the bicycle is facing;
detecting a direction and a pathway of a bike lane that the bicycle is following; and
determining a speed of the bicycle.

18. The method of claim 13, wherein the sensor data are acquired by at least one sensor equipped on a vehicle traveling in the area that the bicycle is traveling in, wherein the method further comprises providing the predicted trajectory of the bicycle to the vehicle.

19. A non-transitory computer-readable medium having instructions stored thereon that, when executed by at least one processor, causes the at least one processor to perform operations comprising:
receiving a map of an area in which the bicycle is traveling and sensor data acquired associated with the bicycle;
positioning the bicycle in the map;
identifying the cyclist riding the bicycle;
identifying one or more objects surrounding the bicycle based on the positioning of the bicycle;
extracting features of the bicycle, the cyclist, and the one or more objects from the sensor data; and
predicting the trajectory of the bicycle based on the extracted features using a learning model.

20. The computer-readable medium of claim 19, wherein extracting features further comprises:
detecting a hand signal of the cyclist;
determining a status of a pedestrian traffic light that the bicycle is facing;
detecting a direction and a pathway of a bike lane that the bicycle is following; and
determining a speed of the bicycle.
